(19) United States
(12) Patent Application Publication
(10) Pub. No.: US 2026/0208788 A1
(43) Pub. Date: Jul. 23, 2026

(54) TRANSIENT STEERING SYSTEM FOR A STEER-BY-WIRE SYSTEM FOR A VEHICLE

(71) Applicant: GM Global Technology Operations LLC, Detroit, MI (US)

(72) Inventor: Gabriel de Paula Eduardo, Brighton, MI (US)

(73) Assignee: GM Global Technology Operations LLC, Detroit, MI (US)

(21) Appl. No.: 19/028,328

(22) Filed: Jan. 17, 2025

(51) Int. Cl. B62D 6/00

(52) U.S. Cl. CPC B62D 6/00

(57) ABSTRACT

A computer-implemented method when executed by data processing hardware causes the data processing hardware to perform operations including calibrating a transient steering algorithm with a baseline steering ratio and receiving, at the transient steering algorithm, a first set of vehicle data. The vehicle data includes one or more of a vehicle speed, a steering angle, lateral acceleration, a yaw rate, and steering wheel torque. The operations include manipulating, based on a steering angle gradient, the baseline steering ratio, determining, via the transient steering algorithm, a phasing gain based on a proportional transient variable and the lateral acceleration and longitudinal acceleration, generating, via the transient steering algorithm, a first steering ratio in response to the first set of vehicle data, the first steering ratio is different from the baseline steering ratio, and adjusting, at a steering system of a vehicle, a steering control based on the first steering ratio.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a transient steering system and, more specifically, to a transient steering system for a steer-by-wire system for a vehicle.

Vehicles are equipped with steering mechanisms including a steering wheel that is mechanically connected to wheels of the vehicle. Many steering mechanisms include a steering shaft, column, or other mechanical structure to couple or otherwise provide steering movement between the steering wheel and the wheels.

Some vehicles may be equipped with a steer-by-wire system, which provides steering between the steering wheel and the wheels without the use of a steering column. Steer-by-wire removes mechanical connections and utilizes a relationship between the steering wheel and the wheels, such that the wheels are responsive to a degree of movement of the steering wheel. However, many steer-by-wire implementations may not account for changes in acceleration or lateral movement of the vehicle that may affect the steering wheel movement relative to the degree of movement of the steering wheel. Thus, there is a need for an improved steer-by-wire system.

### SUMMARY

In some aspects, a computer-implemented method when executed by data processing hardware causes the data processing hardware to perform operations. The operations include calibrating a transient steering algorithm with a baseline steering ratio and receiving, at the transient steering algorithm, a first set of vehicle data. The vehicle data includes one or more of a vehicle speed, a steering angle, lateral acceleration, a yaw rate, and steering wheel torque. The operations also include manipulating, based on a steering angle gradient, the baseline steering ratio, determining, via the transient steering algorithm, a phasing gain based on a proportional transient variable and the lateral acceleration and longitudinal acceleration, and generating, via the transient steering algorithm, a first steering ratio in response to the first set of vehicle data. The first steering ratio is different from the baseline steering ratio. The operations further include adjusting, at a steering system of a vehicle, a steering control based on the first steering ratio.

The operations may optionally include receiving, at the transient steering algorithm, a second set of vehicle data and generating a second steering ratio in response to the second set of vehicle data. The second steering ratio may be different from the first steering ratio. The operations may further include adjusting the steering control based on the second steering ratio. In some instances, generating the first steering ratio and the second steering ratio may include defining an updated ratio between the first steering ratio, the second steering ratio, and a road wheel angle. Optionally, generating the first steering ratio and the second steering ratio may include using the lateral acceleration to define the steering angle.

In some examples, the first steering ratio may correspond to a first rate of speed of the vehicle speed and the second steering ratio may correspond to a second rate of speed of the vehicle speed, the second rate of speed being different from the first rate of speed. The operations may include identifying, via the transient steering algorithm, a predefined rate of change of the second set of vehicle data compared with the first set of vehicle data. Optionally, generating the second steering ratio may include comparing the second rate of speed of the vehicle speed with the predefined rate of change. In some instances, the baseline steering ratio and the first steering ratio may be defined by a quotient between the steering angle and a road wheel angle.

In other aspects, a transient steering system for a steer-by-wire system of a vehicle includes data processing hardware and memory hardware in communication with the data processing hardware. The memory hardware stores instructions that when executed on the data processing hardware cause the data processing hardware to perform operations. The operations include calibrating a transient steering algorithm with a baseline steering ratio and receiving, at the transient steering algorithm, a first set of vehicle data. The vehicle data includes one or more of a vehicle speed, a steering angle, lateral acceleration, a yaw rate, and steering wheel torque. The operations also include manipulating, based on a steering wheel angle gradient, the baseline steering ratio, determining, via the transient steering algorithm, a phasing gain based on a proportional transient variable and the lateral acceleration and longitudinal acceleration, and generating, via the transient steering algorithm, a first steering ratio in response to the first set of vehicle data. The first steering ratio is different from the baseline steering ratio. The operations further include adjusting, at the steer-by-wire system of the vehicle, a steering control based on the first steering ratio.

The operations may optionally include receiving, at the transient steering algorithm, a second set of vehicle data and generating a second steering ratio in response to the second set of vehicle data, the second steering ratio being different from the first steering ratio. In some instances, the operations may include adjusting the steering control based on the second steering ratio. In some examples, generating the first steering ratio and the second steering ratio may include defining an updated ratio between the first steering ratio, the second steering ratio, and a road wheel angle. Optionally, generating the first steering ratio and the second steering ratio may include using the lateral acceleration to define the steering angle.

In some instances, the first steering ratio may correspond to a first rate of speed of the vehicle speed and the second steering ratio may correspond to a second rate of speed of the vehicle speed, the second rate of speed being different from the first rate of speed. The operations may also include identifying, via the transient steering algorithm, a predefined rate of change of the second set of vehicle data compared with the first set of vehicle data. Optionally, generating the second steering ratio may include comparing the second rate of speed of the vehicle speed with the predefined rate of change. In some examples, the baseline steering ratio and the first steering ratio may be defined by a quotient between the steering angle and a road wheel angle.

In other aspects, a transient steering system for a steer-by-wire system of a vehicle includes data processing hardware and memory hardware in communication with the data processing hardware. The memory hardware stores instructions that when executed on the data processing hardware cause the data processing hardware to perform operations. The operations include calibrating a transient steering algorithm with a baseline steering ratio and receiving, at the transient steering algorithm, a first set of vehicle data. The vehicle data includes one or more of a vehicle speed, a steering angle, lateral acceleration, a yaw rate, and steering wheel torque. The operations also include manipulating, based on a steering wheel angle gradient, the baseline steering ratio, determining, via the transient steering algorithm, a phasing gain based on a proportional transient variable and the lateral acceleration and longitudinal acceleration, and generating, via the transient steering algorithm, a first steering ratio in response to the first set of vehicle data. The first steering ratio is different from the baseline steering ratio. The operations further include adjusting, at the steer-by-wire system of the vehicle, a steering control based on the first steering ratio, receiving, at the transient steering algorithm, a second set of vehicle data, generating a second steering ratio in response to the second set of vehicle data, the second steering ratio being different from the first steering ratio, and adjusting the steering control based on the second steering ratio.

In some examples, the baseline steering ratio and the first steering ratio may be defined by a quotient between the steering angle and a road wheel angle.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with a steer-by-wire system configured with a transient steering system according to the present disclosure;

FIG. 2 is a partial perspective view of an interior of a vehicle equipped with the transient steering system according to the present disclosure;

FIG. 3 is an exemplary block diagram of a transient steering system according to the present disclosure;

FIG. 4 is a schematic diagram of operations of a transient steering system according to the present disclosure;

FIG. 5 is an exemplary graphical representation of a lookup table for a transient steering system according to the present disclosure;

FIGS. 6 and 7 are further schematic diagrams of operations of a transient steering system according to the present disclosure;

FIGS. 8-13 are exemplary graphical representations of a steering ratio, vehicle speed, acceleration, and steering wheel angle of a vehicle equipped with a transient steering system according to the present disclosure in comparison with a baseline vehicle not equipped with the transient steering system; and

FIG. 14 is an exemplary method of execution of a transient steering system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

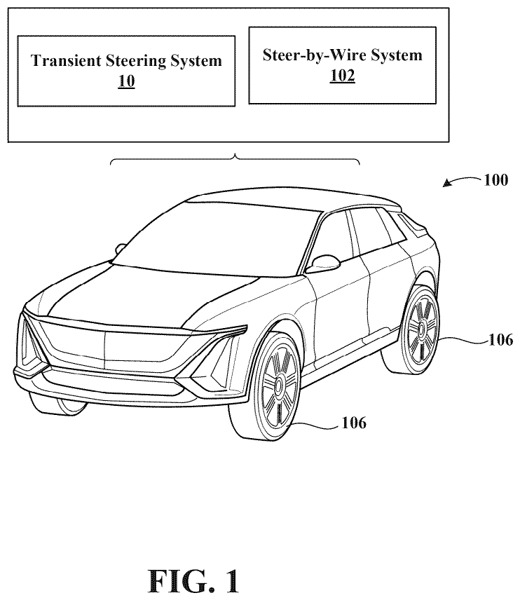

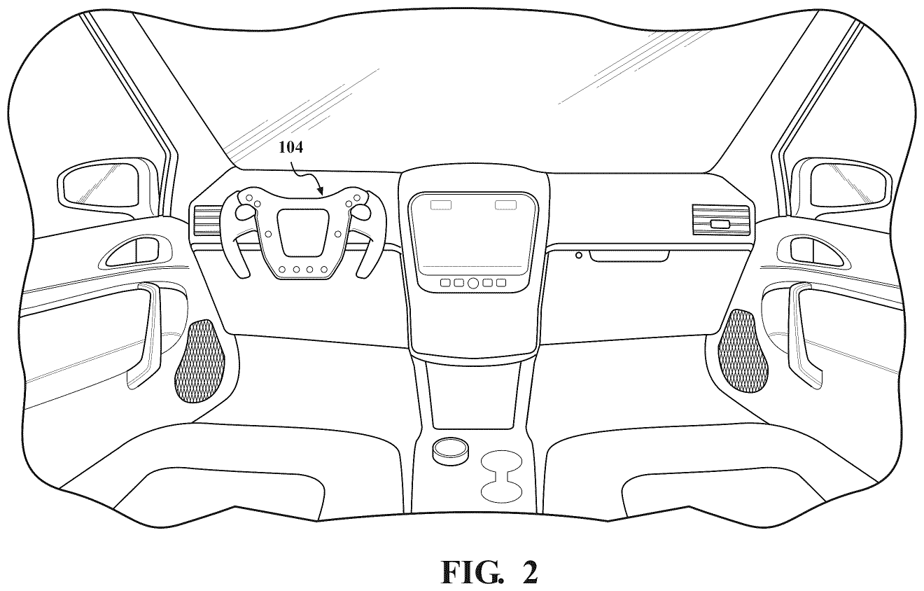

Referring to FIGS. 1-3, a vehicle 100 is equipped with a steer-by-wire system 102 configured with a transient steering system 10. The steer-by-wire system 102 includes a steering wheel 104 and road wheels 106 of the vehicle 100. The steering wheel 104 is communicatively and operably coupled to each of the road wheels 106 via the steer-by-wire system 102 to execute a steering maneuver 108 of the vehicle 100. The steering wheel 104 may be configured as a traditional, rounded or circular steering wheel 104 or may be configured as a yolk steering wheel 104. The steer-by-wire system 102 is configured to capture steering data 110 associated with the steering wheel 104 and road wheel data 112 associated with the road wheels 106. The steer-by-wire system 102 is also configured to communicate the steering data 110 and the road wheel data 112 with the transient steering system 10. The steering data 110 and the road wheel data 112 may be included as part of vehicle data 114 provided from the steer-by-wire system 102 to the transient steering system 10. The vehicle data 114 may also include, but is not limited to, lateral acceleration 116, a yaw rate 118, and a vehicle speed 120. The steering data 110 may include, but is not limited to, a steering angle 110a and steering wheel torque 110b.

The transient steering system 10 includes an electronic control unit (ECU) 12 configured with a transient steering algorithm 14. The transient steering algorithm 14 receives the steering data 110 and the road wheel data 112. The ECU 12 includes data processing hardware 16 that is configured to execute the transient steering algorithm 14 and memory hardware 18 in communication with the data processing hardware 16. The memory hardware 18 stores instructions that, when executed on the data processing hardware 16, cause the data processing hardware 16 to perform operations, described herein. The transient steering algorithm 14 is configured with a steering ratio 20 associated with the steer-by-wire system 102. For example, the transient steering algorithm 14 may be initially calibrated with a baseline steering ratio 20a. The baseline steering ratio 20a may also be established after a predetermined duration of operative time of the vehicle 100.

The steering ratio 20 reflects the effect of the steering angle 110a on a road wheel angle 112a. For example, the greater the steering ratio 20 the less of an effect the steering angle 110a will have on the road wheel angle 112a. In other words, an operator will manipulate the steering wheel 104 to a greater steering angle 110a in order to result in a desired change in the road wheel angle 112a when the steering ratio 20 is high. Comparatively, a lower or lesser steering ratio 20 may provide the operator with the ability to make minor changes to the steering angle 110a to effectuate a greater change in the road wheel angle 112a. Thus, the road wheels 106 may have an increased responsiveness to the steering wheel 104 when the steering ratio 20 is small and may have a decreased responsiveness to the steering wheel when the steering ratio 20 is large. Further, the steering ratio 20 is influenced by the other vehicle data 114, in addition to the steering angle 110a and the road wheel angle 112a, including, but not limited to, the lateral acceleration 116, the yaw rate 118, and the vehicle speed 120 at an initial measurement.

As mentioned above, the steering ratio 20 includes the baseline steering ratio 20a, which represents an initial steering ratio 20a that may be configured as part of the steer-by-wire system 102. For example, the baseline steering ratio 20a may be predetermined based on average vehicle data 114 stored in a server or may be calculated after a predetermined duration of initial operative time of the vehicle 100. The baseline steering ratio 20a is designed to be a starting point from which the transient steering system 10 can adjust the effect of movement of the steering wheel 104 on the road wheels 106. The transient steering system 10 communicates changes to the steering ratio 20 (i.e., adjustment of the baseline steering ratio 20a) with the steer-by-wire system 102, and the steer-by-wire system 102 implements changes to the steering ratio 20 at the steering wheel 104 and the road wheels 106.

The transient steering algorithm 14 is configured to apply a phasing gain 22 based on the steering ratio 20 in response to the vehicle data 114. By way of example, not limitation, the phasing gain 22 may be applied in response to the vehicle data 114 reflecting one of a braking event and a high lateral acceleration event (i.e., a high gravitational (G)-force event). The phasing gain 22 is utilized by the steer-by-wire system 102 to phase out or delay the movement of the road wheels 106 in response to the detected movement of the steering wheel 104. Thus, the phasing gain 22 is directly proportional to the steering ratio 20 to alter the responsiveness of the road wheels 106 to the steering wheel 104.

With further reference to FIGS. 1-3, the transient steering algorithm 14 is configured to set and adjust the steering ratio 20 in response to the vehicle data 114, as mentioned above, after the baseline steering ratio 20a has been calibrated. During operation of the vehicle 100, the transient steering algorithm 14 receives a first set 114a of the vehicle data 114 from the steer-by-wire system 102. The first set 114a of the vehicle data 114 is captured during a predetermined time frame of operation of the vehicle 100. For example, the first set 114a may reflect changes to one or more of the lateral acceleration 116, the yaw rate 118, and the vehicle speed 120. Based on the first set 114a of the vehicle data 114, the transient steering algorithm 14 may adjust or otherwise alter the steering ratio 20 to generate a first steering ratio 20b, which is different from the baseline steering ratio 20a. For example, the transient steering algorithm 14 may manipulate the baseline steering ratio 20a based on a steering angle gradient 110c of the steering data 110. The steering angle gradient 110c is calculated by the transient steering algorithm 14 based on the vehicle speed 120 and the steering angle 110a and reflects a steering wheel velocity 110d.

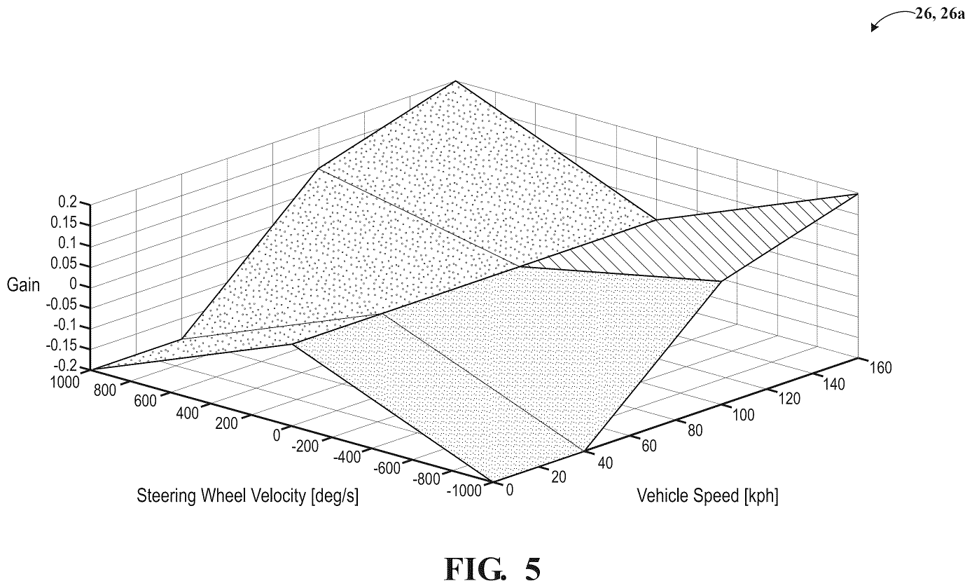

The transient steering algorithm 14 may then determine the phasing gain 22 based on a proportional transient variable 24 as well as the lateral acceleration 116 and longitudinal acceleration 122 of the vehicle data 114. The proportional transient variable 24 may be stored in a lookup table 26, which may be stored in the memory hardware 18. An exemplary lookup table 26 is illustrated at FIG. 5. The lookup table 26 may include a two-dimensional lookup table 26a and various one-dimensional lookup tables 26b-d. The lookup table 26 is tunable relative to the steering angle gradient 110c and the vehicle speed 120. For example, the lookup table 26 is illustrated with the phasing gain 22 along a y-axis, the steering wheel velocity 110d along an x-axis, and the vehicle speed 120 along a z-axis. The lookup table 26 may be utilized by the transient steering algorithm 14 to determine, at least in part, the updated steering ratio 20b (i.e., the first steering ratio 20b) with the phasing gain 22. The transient steering algorithm 14 communicates the first steering ratio 20b with the steer-by-wire system 102, and the steer-by-wire system 102 adjusts a steering control 130 based on the first steering ratio 20b. As noted above, the first steering ratio 20b is different from the baseline steering ratio 20a. The first steering ratio 20b and the second steering ratio 20c are defined by a quotient 111 between the steering angle 110a and the road wheel angle 112a.

The steer-by-wire system 102 continues to collect and monitor the vehicle data 114 during operation of the vehicle 100 and continually sends the vehicle data 114 to the transient steering system 10 for assessment. For example, the transient steering system 10 may receive a second set 114b of the vehicle data 114 from the steer-by-wire system 102 after having adjusted the steering ratio 20 in response to the first set 114a of the vehicle data 114. The second set 114b of the vehicle data 114 may be different from the first set 114a of the vehicle data 114, such that the transient steering algorithm 14 may generate a second steering ratio 20c. The transient steering algorithm 14 defines an updated ratio 28 between the first steering ratio 20b, the second steering ratio 20c, and the road wheel angle 112a. The steer-by-wire system 102 receives the second steering ratio 20c from the transient steering system 10 and adjusts the steering control 130 based on the second steering ratio 20c. In some instances, the transient steering algorithm 14 may be configured with a predefined rate of change 30 associated with the second steering ratio 20c, described in more detail below.

In one non-limiting example, the transient steering algorithm 14 may utilize the lateral acceleration 116 to define the steering angle 110a. The lateral acceleration 116 may change from the first set 114a of the vehicle data 114 to the second set 114b of the vehicle data 114 indicating to the transient steering algorithm 14 that the steering ratio 20 should be adjusted. For example, the vehicle 100 may enter a turn or curve that corresponds to a high G-force event. The transient steering algorithm 14 may compare the second set 114b to the first set 114a of the vehicle data 114 to generate the second steering ratio 20c. In this non-limiting example, the second steering ratio 20c may be greater than the first steering ratio 20b to reduce the effect of the steering angle 110a on the road wheel angle 112a.

In another non-limiting example, the transient steering algorithm 14 may utilize the vehicle speed 120 to define the steering ratio 20. For example, the transient steering algorithm 14 may initially receive the first set 114a of vehicle data 114 including a first rate of speed 120a and subsequently receive the second set 114b of vehicle data 114 including a second rate of speed 120b that is different from the first rate of speed 120a. The transient steering algorithm 14 is configured to assess the difference between the first rate of speed 120a and the second rate of speed 120b to determine how to adjust the steering ratio 20. For example, if there is a large drop in the vehicle speed 120 from the first rate of speed 120a to the second rate of speed 120b, then the steering ratio 20 may be increased to limit the effect of the steering angle 110a on the road wheel angle 112a. In this non-limiting example, the increased steering ratio 20 results in large movements or adjustments of the steering wheel 104 effecting minor movements or adjustments at the road wheels 106.

The predefined rate of change 30 may be stored in the memory hardware 18 and may be defined relative to the vehicle speed 120. For example, the predefined rate of change 30 is a defined threshold of change in the vehicle speed 120 at which the transient steering algorithm 14 is triggered to increase or decrease the steering ratio 20 (i.e., alter the steering ratio 20 from the first steering ratio 20b to the second steering ratio 20c). Thus, when the transient steering algorithm 14 receives the second set 114b of vehicle data 114, the transient steering algorithm 14 compares the second rate of speed 120b with the predefined rate of change 30 to determine whether to adjust or alter the steering ratio 20.

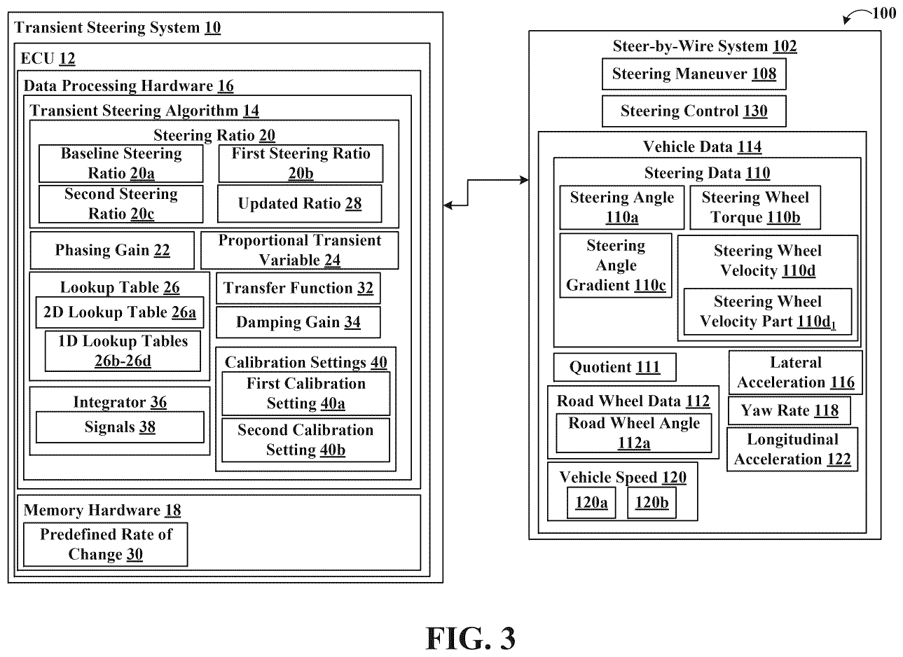

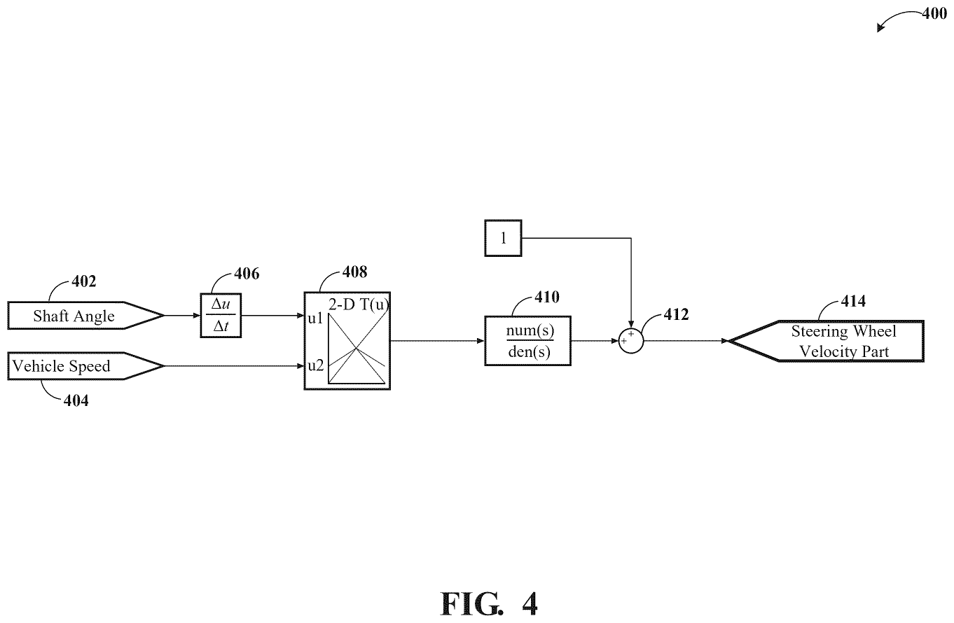

With reference now to FIGS. 3-7, exemplary diagrams for executing the transient steering algorithm 14 are illustrated. FIG. 4 illustrates a first flow diagram 400 that utilizes the steering angle 110a, at 402, and the vehicle speed 120, at 404. The transient steering algorithm 14 calculates, at 406, the steering angle gradient 110c. Based on the steering angle gradient 110c and the vehicle speed 120, the transient steering algorithm 14 evaluates, at 408, the lookup table 26 (illustrated in FIG. 5) to determine the phasing gain 22. The phasing gain 22 is a function of the vehicle speed 120 and the steering wheel velocity 110d. The transient steering algorithm 14 then applies, at 410, a transfer function 32 the phasing gain 22 to increase or decrease the steering ratio 20. A value of one (1) is added, at 412, so the result is scalar over the steering ratio 20, which results, at 414, in a steering wheel velocity part 110d₁.

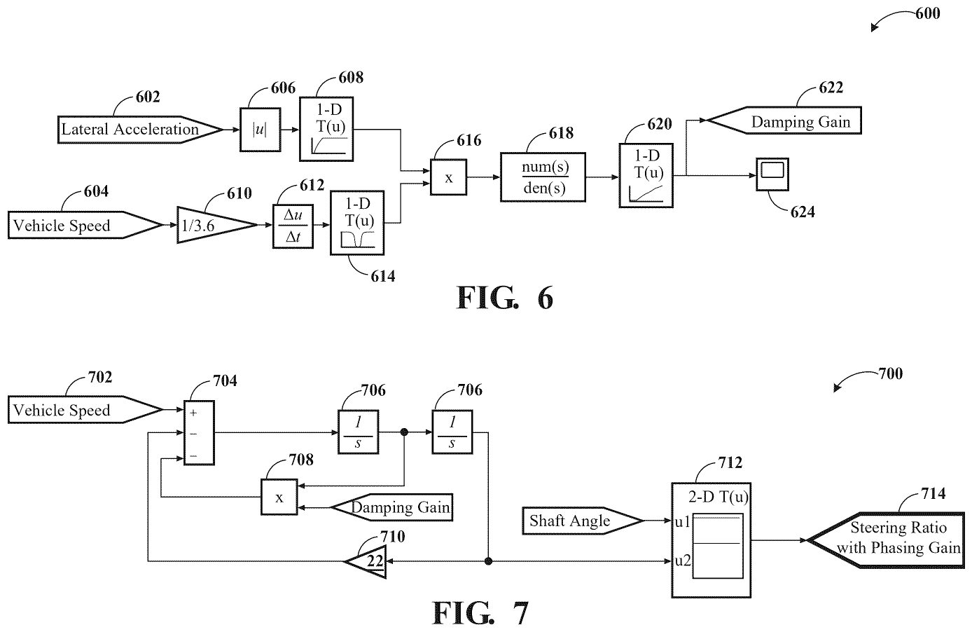

FIG. 6 illustrates another flow diagram 600 that utilizes the lateral acceleration 116, at 602, and the vehicle speed 120, at 604. At 606, the absolute value of the lateral acceleration 116 is determined and, at 608, is put into a one-dimensional lookup table 26b. The vehicle speed 120 is converted, at 610, from kilometers per hour to meters per second. The transient steering algorithm 14 then calculates, at 612, the longitudinal acceleration 122 and applies, at 614, a scalar via a second, one-dimensional lookup table 26c. The second, one-dimensional lookup table 26c contains both positive and negative values, whereas the one-dimensional lookup table 26b only contains positive values. The positive values represent acceleration and the negative values represent braking. The scaled values resulting from the one-dimensional lookup tables 26b, 26c are multiplied, at 616, and the transfer function 332 is applied, at 618, to smooth the signal. Another one-dimensional table 26d is applied, at 620, to the phasing gain 22 resulting in one of a damping gain 34, at 622, and a damping to the phasing gain 22, at 624.

FIG. 7 illustrates a further flow diagram 700 that utilizes the vehicle speed 120, at 702, and operates in a loop utilizing the damping gain 34 from the flow diagram 600. The transient steering algorithm 14 executes, at 704, the transfer function 32 by adding or subtracting the vehicle speed 120 to other signals. At 706, an integrator 36 of the transient steering algorithm 14 outputs signals 38. In one instance, the signals 38 are multiplied, at 708, with the damping gain 34 and then circulated back to the transfer function 32, at 704. In another instance, the signals 38 are adjusted by removing, at 710, the phasing gain 22 and then circulated back to the transfer function 32, at 704. The signals 38 may also be input, at 712, to the two-dimensional lookup table 26a along with the steering angle 110a, which results in the steering ratio 20 with the phasing gain 22, at 714.

The transient steering algorithm 14 utilizes each of the flow diagrams 400, 600, and 700 to calculate the steering ratio 20 utilizing the various vehicle data 114. Once the transient steering algorithm 14 determines the steering ratio 20 with the phasing gain 22, at 714, the transient steering algorithm 14 may multiply the steering ratio 20 with the phasing gain 22 with the steering wheel velocity part 110d₁, generated at 412. This calculation results in the final steering ratio 20 that is utilized by the steer-by-wire system 102. As described herein, the transient steering algorithm 14 is configured to execute these steps in response to a detected change in the steering angle 110a and/or other vehicle data 114 that may indicate that a reduction or increase in steering ratio 20 would benefit performance of the vehicle 100. The transient steering algorithm 14 is configured to execute these calculations during a transient period between phases of a maneuver, such that the change in steering ratio 20 is gradual for the operator.

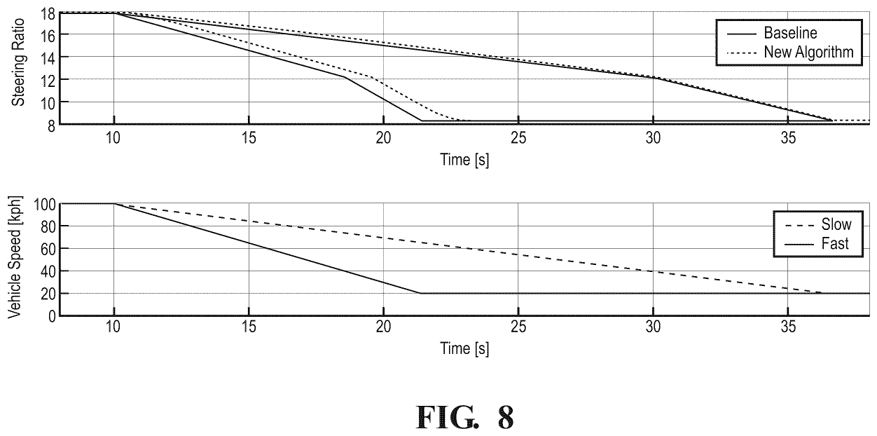

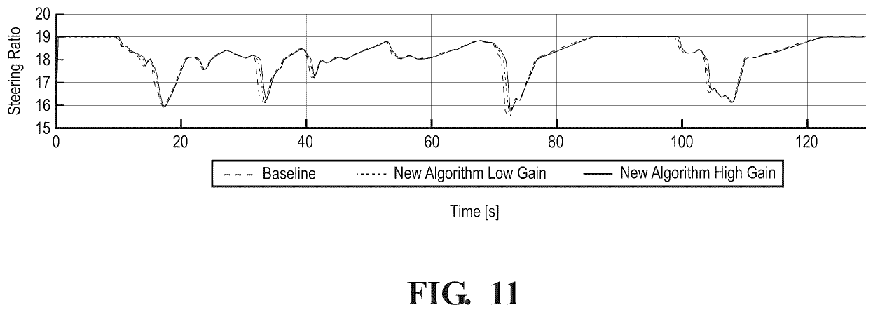

FIGS. 8-13 illustrate graphical examples of the effect of the implementation of the transient steering algorithm 14. For example, FIG. 7 illustrates the steering ratio 20 at a given time. In this example, if the steering ratio 20 is reading eighteen (18) degrees at the steering wheel 104, then the road wheel 106 will read at one (1) degree. As a result, the steering ratio 20 is eighteen (18). In the same example, if the vehicle 100 is operating at a vehicle speed 120 of approximately 100 kilometers per hour (kph) and braking is executed to transition to twenty (20) kph, then the steering ratio 20 will decrease resulting in greater control of the vehicle 100. For example, the steering ratio 20 may be reduced from approximately eighteen (18) to approximately eight (8) when reducing from 100 kph to twenty (20) kph.

The baseline data in FIG. 8 illustrates that, without the steering ratio 20, the phasing gain 22 would be proportional to the acceleration level and the lateral acceleration level. As a result, if there is rapid braking, then the steering angle 110a relative to the road wheel angle 112a may remain unchanged. Comparatively, the transient steering algorithm 14 follows the change in braking, such that the steering ratio 20 may change slowly in response to a slow braking maneuver and may change quickly in response to a quick braking maneuver. The transient steering algorithm 14 is thus configured to smooth the transition from when the vehicle 100 is operating at a high speed as compared to the transition to operating at a slower speed. For example, when the vehicle 100 is operating at the high speed, the steering ratio 20 is higher relative to when the vehicle 100 is operating at a slower speed. The higher steering ratio 20 results in minimal effect on the road wheels 106, such that an operator may make minor adjustments to the steering wheel 104 with minimal to no effect on the road wheels 106.

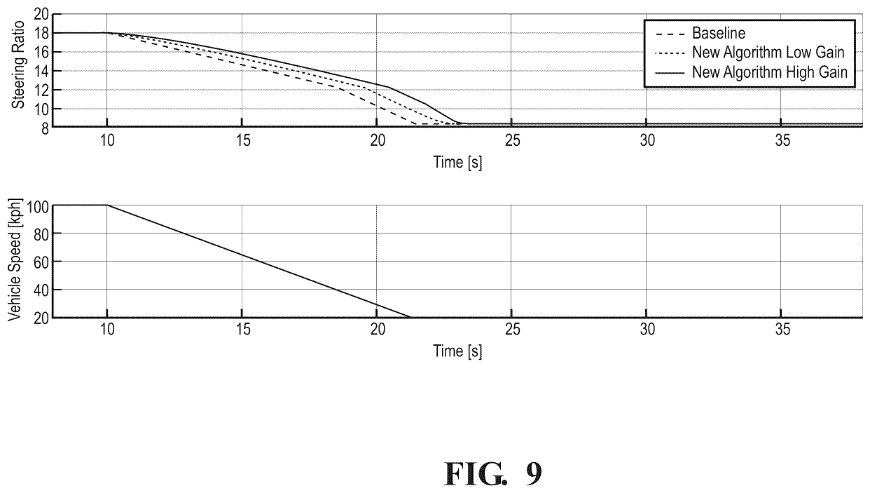

In comparison, when operating at the slower speed, the steering ratio 20 is lower, so maneuvers of the steering wheel 104 have a greater effect on the road wheels 106. The transient steering algorithm 14 is also configured to smooth the transition of the steering ratio 20 between high vehicle speed 120 and low vehicle speed 120 to result in an improved drivability and handling of the vehicle 100. As mentioned above, the transient steering algorithm 14 is configured to monitor the vehicle data 114 to determine the degree of adjustment of the steering ratio 20. The transient steering algorithm 14 is configured with multiple calibration settings 40, illustrated in FIG. 9, to adjust the steering ratio 20. For example, a first calibration setting 40a may correspond to an aggressive (i.e., rapid) braking maneuver with a second calibration setting 40b corresponding to a slower braking maneuver. The first calibration setting 40a may be represented by a low gain, and the second calibration settings 40b may be represented by a high gain.

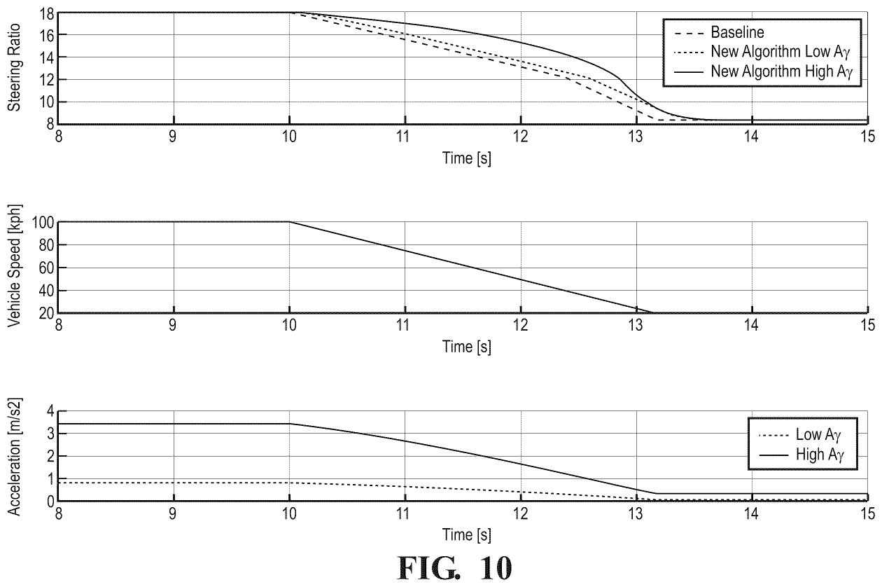

The calibration settings 40 may correspond with the lateral acceleration 116. For example, FIG. 10 illustrates an example of the first calibration setting 40a corresponding to low lateral acceleration 116a and the second calibration setting 40b corresponding to high lateral acceleration 116b. The steering ratio 20 may be adjusted based on the calibration settings 40 in response to the detected lateral acceleration 116. Thus, the more aggressive (i.e., stronger) the gravitational (G) force resulting from the lateral acceleration 116, the slower the change to the steering ratio 20. This provides the operator with an improved sensation of control of the vehicle 100 during operation through high G-force areas of the road that result in high levels of lateral acceleration 116. For example, the transient steering algorithm 14 is configured to have a lesser change to the steering ratio 20 at a corner with high lateral acceleration 116b as compared to a corner with low lateral acceleration 116a.

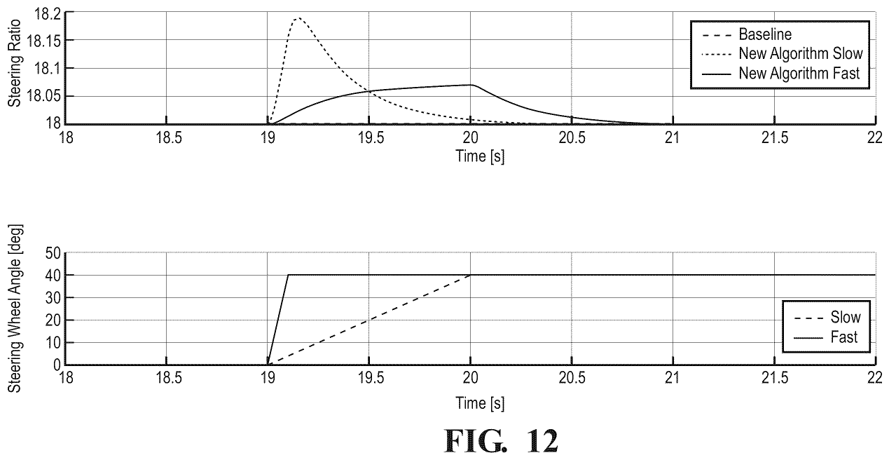

The transient steering algorithm 14 is also configured to respond to the steering angle 110a based on a speed of change of the steering angle 110a (i.e., how quickly the operator changes the steering angle 110a). For example, FIG. 12 illustrates the steering angle 110a changing from zero (0) degrees to forty (40) degrees at a high rate of speed 120 (i.e., fast) and comparatively changing from zero (0) degrees to forty (40) degrees at a low rate of speed 120 (i.e., slow). The transient steering algorithm 14 is configured to change the steering ratio 20 during the transition from zero (0) to forty (40). Thus, the steering angle 110a and the road wheel angle 112a will change as a result of the change to the steering ratio 20, such that during the transient time when the steering ratio 20 is changed the steering angle 110a will have a greater or lesser effect on the road wheel angle 112a, depending, at least in part, on the vehicle speed 120. The result of the change to the steering ratio 20 by the transient steering algorithm 14 is faster or slower responsiveness of the road wheels 106 to a maneuver made at the steering wheel 104 during the transient time between vehicle speeds 120.

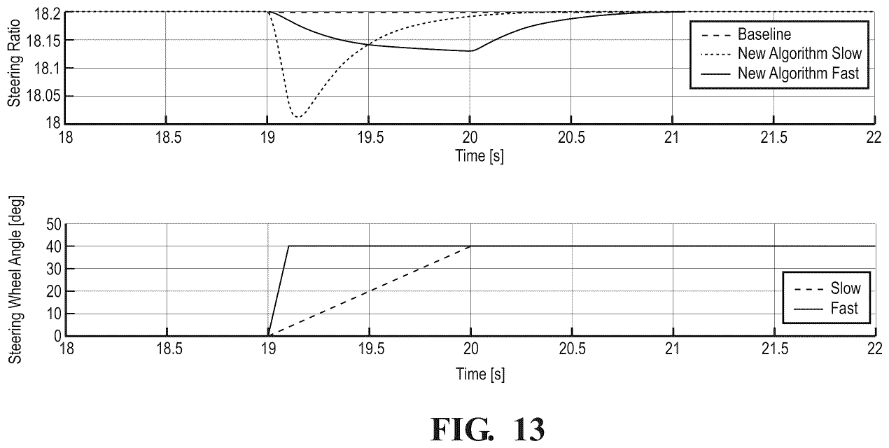

In some instances, the vehicle 100 may be configured to tow another object, such as a trailer. In this example, illustrated in FIG. 13, an aggressive (i.e., rapid or quick) maneuver at the steering wheel 104 and, thus, an aggressive change to the steering angle 110a would not result in a rapid change to the road wheel angle 112a because of the transient steering algorithm 14. The transient steering algorithm 14 would correct for such a maneuver and would adjust the steering ratio 20 accordingly. The transient steering algorithm 14 is configured to adapt the steering ratio 20 in real-time, such that the steering ratio 20 may be increased in response to the aggressive maneuver and decreased once the aggressive maneuver has ceased. The transient steering algorithm 14 is configured to provide a smooth or otherwise mild change across a period of time to the steering ratio 20 to minimize the effect on an operator.

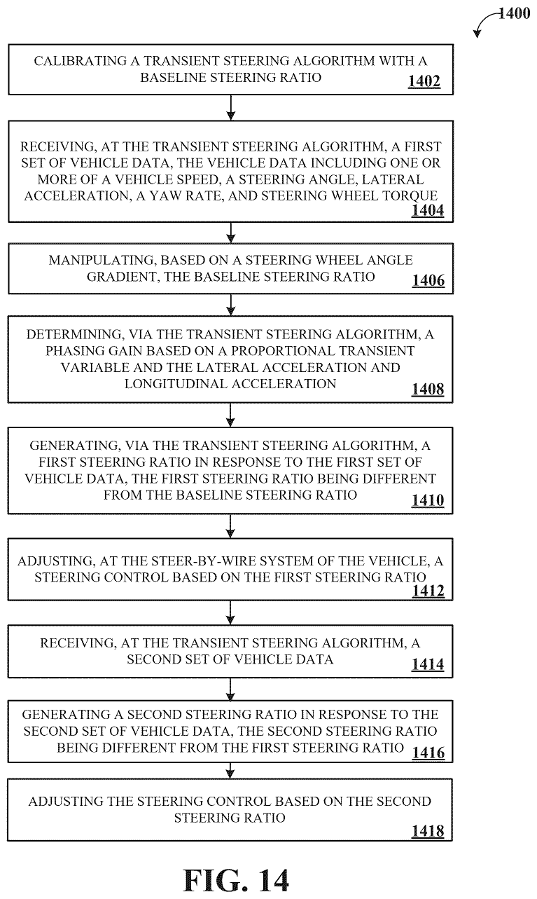

Referring to FIG. 14, an exemplary method 1400 of the transient steering system 10 is illustrated. At 1402, the transient steering system 10 calibrates a transient steering algorithm 14 with a baseline steering ratio 20a. The transient steering algorithm 14 receives, at 1404, a first set 114a of vehicle data 114. The vehicle data 114 includes one or more of a vehicle speed 120, a steering angle 110a, lateral acceleration 116, a yaw rate 118, and steering wheel torque 110b. The transient steering algorithm 14 manipulates, at 1406, based on a steering angle gradient 110c, the baseline steering ratio 20a. The transient steering algorithm 14 determines, at 1408, a phasing gain 22 based on a proportional transient variable 24 and the lateral acceleration 116 and longitudinal acceleration 122. At 1410, the transient steering algorithm 14 generates a first steering ratio 20b in response to the first set 114a of vehicle data 114. The first steering ratio 20b is different from the baseline steering ratio 20a. A steer-by-wire system 102 of the vehicle 100 adjusts, at 1412, a steering control 130 based on the first steering ratio 20b. The transient steering algorithm 14, at 1414, receives a second set 114b of vehicle data 114 and generates, at 1416 a second steering ratio 20c in response to the second set 114b of vehicle data 114. The second steering ratio 20c is different from the first steering ratio 20b. The steer-by-wire system 102 adjusts, at 1418, the steering control 130 based on the second steering ratio 20c.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
calibrating a transient steering algorithm with a baseline steering ratio;
receiving, at the transient steering algorithm, a first set of vehicle data, the vehicle data including one or more of a vehicle speed, a steering angle, lateral acceleration, a yaw rate, and steering wheel torque;
manipulating, based on a steering angle gradient, the baseline steering ratio;
determining, via the transient steering algorithm, a phasing gain based on a proportional transient variable and the lateral acceleration and longitudinal acceleration;
generating, via the transient steering algorithm, a first steering ratio in response to the first set of vehicle data, the first steering ratio being different from the baseline steering ratio; and
adjusting, at a steering system of a vehicle, a steering control based on the first steering ratio.

2. The method of claim 1, further including receiving, at the transient steering algorithm, a second set of vehicle data and generating a second steering ratio in response to the second set of vehicle data, the second steering ratio being different from the first steering ratio.

3. The method of claim 2, further including adjusting the steering control based on the second steering ratio.

4. The method of claim 3, wherein generating the first steering ratio and the second steering ratio includes defining an updated ratio between the first steering ratio, the second steering ratio, and a road wheel angle.

5. The method of claim 3, wherein generating the first steering ratio and the second steering ratio includes using the lateral acceleration to define the steering angle.

6. The method of claim 2, wherein the first steering ratio corresponds to a first rate of speed of the vehicle speed and the second steering ratio corresponds to a second rate of speed of the vehicle speed, the second rate of speed being different from the first rate of speed.

7. The method of claim 6, further including identifying, via the transient steering algorithm, a predefined rate of change of the second set of vehicle data compared with the first set of vehicle data.

8. The method of claim 7, wherein generating the second steering ratio includes comparing the second rate of speed of the vehicle speed with the predefined rate of change.

9. The method of claim 1, wherein the baseline steering ratio and the first steering ratio are defined by a quotient between the steering angle and a road wheel angle.

10. A transient steering system for a steer-by-wire system of a vehicle, the transient steering system comprising:
data processing hardware; and
memory hardware in communication with the data processing hardware, the memory hardware storing instructions that when executed on the data processing hardware cause the data processing hardware to perform operations comprising:
calibrating a transient steering algorithm with a baseline steering ratio;
receiving, at the transient steering algorithm, a first set of vehicle data, the vehicle data including one or more of a vehicle speed, a steering angle, lateral acceleration, a yaw rate, and steering wheel torque;
manipulating, based on a steering wheel angle gradient, the baseline steering ratio;
determining, via the transient steering algorithm, a phasing gain based on a proportional transient variable and the lateral acceleration and longitudinal acceleration;
generating, via the transient steering algorithm, a first steering ratio in response to the first set of vehicle data, the first steering ratio being different from the baseline steering ratio; and
adjusting, at the steer-by-wire system of the vehicle, a steering control based on the first steering ratio.

11. The transient steering system of claim 10, further including receiving, at the transient steering algorithm, a second set of vehicle data and generating a second steering ratio in response to the second set of vehicle data, the second steering ratio being different from the first steering ratio.

12. The transient steering system of claim 11, further including adjusting the steering control based on the second steering ratio.

13. The transient steering system of claim 12, wherein generating the first steering ratio and the second steering ratio includes defining an updated ratio between the first steering ratio, the second steering ratio, and a road wheel angle.

14. The transient steering system of claim 12, wherein generating the first steering ratio and the second steering ratio includes using the lateral acceleration to define the steering angle.

15. The transient steering system of claim 11, wherein the first steering ratio corresponds to a first rate of speed of the vehicle speed and the second steering ratio corresponds to a second rate of speed of the vehicle speed, the second rate of speed being different from the first rate of speed.

16. The transient steering system of claim 15, further including identifying, via the transient steering algorithm, a predefined rate of change of the second set of vehicle data compared with the first set of vehicle data.

17. The transient steering system of claim 16, wherein generating the second steering ratio includes comparing the second rate of speed of the vehicle speed with the predefined rate of change.

18. The transient steering system of claim 10, wherein the baseline steering ratio and the first steering ratio are defined by a quotient between the steering angle and a road wheel angle.

19. A transient steering system for a steer-by-wire system of a vehicle, the transient steering system comprising:
data processing hardware; and
memory hardware in communication with the data processing hardware, the memory hardware storing instructions that when executed on the data processing hardware cause the data processing hardware to perform operations comprising:
calibrating a transient steering algorithm with a baseline steering ratio;
receiving, at the transient steering algorithm, a first set of vehicle data, the vehicle data including one or more of a vehicle speed, a steering angle, lateral acceleration, a yaw rate, and steering wheel torque;
manipulating, based on a steering wheel angle gradient, the baseline steering ratio;
determining, via the transient steering algorithm, a phasing gain based on a proportional transient variable and the lateral acceleration and longitudinal acceleration;
generating, via the transient steering algorithm, a first steering ratio in response to the first set of vehicle data, the first steering ratio being different from the baseline steering ratio;
adjusting, at the steer-by-wire system of the vehicle, a steering control based on the first steering ratio;
receiving, at the transient steering algorithm, a second set of vehicle data;
generating a second steering ratio in response to the second set of vehicle data, the second steering ratio being different from the first steering ratio; and
adjusting the steering control based on the second steering ratio.

20. The transient steering system of claim 19, wherein the baseline steering ratio and the first steering ratio are defined by a quotient between the steering angle and a road wheel angle.
